(19) United States
(12) Patent Application Publication
(10) Pub. No.: US 2017/0336681 A1
(43) Pub. Date: Nov. 23, 2017

(54) PIXEL STRUCTURE AND MANUFACTURING METHOD THEREOF, ARRAY SUBSTRATE AND DISPLAY PANEL

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Weihua JIA, Beijing (CN); Xiaoye MA, Beijing (CN); Haipeng YANG, Beijing (CN); Yongjun YOON, Beijing (CN)

(73) Assignees: BOE TECHNOLOGY GROUP CO., LTD., Beijing (CN); HEFEI XINSHENG OPTOELECTRONICS TECHNOLOGY CO., LTD, Anhui (CN)

(21) Appl. No.: 15/535,450

(22) PCT Filed: Oct. 17, 2016
(86) PCT No.: PCT/CN2016/102261

§ 371 Date: Jun. 13, 2017

(30) Foreign Application Priority Data
Nov. 5, 2015 (CN) 201510745031.4

(51) Int. Cl. G02F 1/1343; G02F 1/1362

(52) U.S. Cl. CPC G02F 1/134309; G02F 1/136286; G02F 1/13439; G02F 2201/123; G02F 2201/124; G02F 2201/121

(57) ABSTRACT

The embodiments of the present invention provide a pixel structure and a manufacturing method thereof, an array substrate and a display panel. The pixel structure includes a plurality of pixel units arranged in an array. Each pixel unit includes a common electrode and a pixel electrode arranged in different layers of a basal substrate. An orthographic projection of the common electrode on the basal substrate does not overlap with an orthographic projection of the pixel electrode on the basal substrate.

### RELATED APPLICATIONS

The present application is the U.S. national phase entry of the international application PCT/CN2016/102261, with an international filing date of Oct. 17, 2016, which claims the benefit of Chinese Patent Application No. 201510745031.4, filed on Nov. 5, 2015, the entire disclosures of which are incorporated herein by reference.

### TECHNICAL FIELD

The present invention relates to the field of display technology, in particular to a pixel structure and a manufacturing method thereof, an array substrate and a display panel.

### BACKGROUND

In the pixel structure of the existing ADS mode, the pixel electrode and the common electrode overlap completely, and the storage capacitance between the pixel electrode and the common electrode is relatively high.

Specifically, see the pixel structure shown in FIG. 1, a common electrode 12, an insulating layer 13 and a pixel electrode 14 are sequentially formed on a basal substrate 11. The storage capacitance generated by the overlap area between the common electrode 12 and the pixel electrode 14 is high, thereby reducing the charge rate of the pixel.

To sum up, in the pixel structure of the prior art, the storage capacitance between the pixel electrode and the common electrode is large, and the charge rate of the pixel is reduced.

### SUMMARY

Therefore, it is desirable to provide a pixel structure and a method for manufacturing the same, an array substrate and a display panel, which can reduce the storage capacitance between the pixel electrode and the common electrode, and improve the charge rate of the pixel.

To this end, an embodiment of the invention provides a pixel structure. The pixel structure includes a plurality of pixel units arranged in an array. Each pixel unit includes a common electrode and a pixel electrode arranged in different layers of a basal substrate. An orthographic projection of the common electrode on the basal substrate does not overlap with an orthographic projection of the pixel electrode on the basal substrate.

In the pixel structure provided by the embodiment of the invention, the common electrode and the pixel electrode arranged in different layers are designed so that the orthographic projection of the common electrode on the basal substrate does not overlap with the orthographic projection of the pixel electrode on the basal substrate. Therefore the storage capacitance between the pixel electrode and the common electrode is reduced, improving the charge rate of the pixel.

According to another embodiment of the invention, both the pixel electrode and the common electrode are comb electrodes, and the pixel electrode and the common electrode are arranged in an interdigitated structure.

According to another embodiment of the invention, each pixel unit includes a first display area and a second display area. In the first display area, the comb electrode of the pixel electrode and the comb electrode of the common electrode are arranged along the same extending direction. In the second display area, the comb electrode of the pixel electrode and the comb electrode of the common electrode are arranged along the same extending direction. The extending direction of the comb electrode in the first display area is different from the extending direction of the comb electrode in the second display area.

According to another embodiment of the invention, the extending directions of the comb electrodes in the first display areas of the plurality of pixel units are the same, and the extending directions of the comb electrodes in the second display areas of the plurality of pixel units are the same.

According to another embodiment of the invention, in each pixel unit, the comb electrode in the first display area is symmetrically distributed with the comb electrode in the second display area, and a boundary line between the first display area and the second display area is the symmetrical axis.

According to another embodiment of the invention, in two adjacent columns of pixel units, the extending direction of the comb electrodes in the first display areas of one column of pixel units is different from the extending direction of the comb electrodes in the first display areas of the other column of pixel units. In two adjacent columns of pixel units, the extending direction of the comb electrodes in the second display areas of one column of pixel units is different from the extending direction of the comb electrodes in the second display areas of the other column of pixel units.

According to another embodiment of the invention, in each pixel unit, the comb electrode in the first display area is symmetrically distributed with the comb electrode in the second display area, and a boundary line between the first display area and the second display area is the symmetrical axis. In two adjacent columns of pixel units, the comb electrodes are symmetrically distributed with respect to a gap between these two adjacent columns of pixel units.

According to another embodiment of the invention, the pixel structure further includes a first common electrode line located at the boundary line between the first display area and the second display area. The first common electrode line connects the common electrode in the first display area and the common electrode in the second display area.

According to another embodiment of the invention, each two adjacent columns of pixel units constitute a pixel unit group, and the pixel units in the pixel unit group are different. The pixel units in a pixel unit group share a data line. A second common electrode line is arranged between two adjacent pixel unit groups, and the second common electrode line connects the common electrodes in two columns of pixel units adjacent to the second common electrode line.

According to another embodiment of the invention, the number of the second common electrode line is more than one. The second common electrode lines are arranged in the same layer with a gate line. The second common electrode lines are electrically connected to each other by means of a plurality of via holes, and each via hole is arranged near a cross position of the second common electrode line and the gate line.

An embodiment of the invention further provides an array substrate including the abovementioned pixel structure.

An embodiment of the invention further provides a display panel including the abovementioned array substrate.

An embodiment of the invention further provides a method for manufacturing the abovementioned pixel structure. The method includes: forming a common electrode on a basal substrate using a composition process, and forming a pixel electrode. An orthographic projection of the common electrode on the basal substrate does not overlap with an orthographic projection of the pixel electrode on the basal substrate.

According to another embodiment of the invention, the step of forming a common electrode on a basal substrate using a composition process includes: forming a common electrode by an exposure development process using a mask plate. The common electrode is a comb electrode.

According to another embodiment of the invention, the step of forming a pixel electrode includes: forming a pixel electrode by an exposure development process using a mask plate. The pixel electrode is a comb electrode. The pixel electrode and the common electrode are arranged in an interdigitated structure.

According to another embodiment of the invention, the mask plate is a halftone mask plate, a gray tone mask plate or a mask plate with slits.

According to another embodiment of the invention, after the step of forming a common electrode and before the step of forming a pixel electrode, the method further includes: forming a first common electrode line on the common electrode.

According to another embodiment of the invention, the method further includes: forming a second common electrode line while forming the first common electrode line.

### BRIEF DESCRIPTION OF THE DRAWINGS

FIG. 1 is a structural schematic diagram of a pixel structure provided by the prior art;

FIG. 2 is a structural schematic diagram of a pixel structure provided by an embodiment of the invention;

FIG. 3 is a structural schematic diagram of a pixel electrode and a common electrode provided by an embodiment of the invention;

FIG. 4 is a structural schematic diagram of a comb electrode provided by an embodiment of the invention;

FIG. 5 is a structural schematic diagram showing an arrangement direction of a pixel electrode and a common electrode provided by an embodiment of the invention;

FIG. 6 is a structural schematic diagram showing an arrangement direction of a pixel electrode and a common electrode provided by another embodiment of the invention;

FIG. 7 is a structural schematic diagram showing an arrangement direction of a pixel electrode and a common electrode provided by yet another embodiment of the invention;

FIG. 8 is a structural schematic diagram showing an arrangement direction of a pixel electrode and a common electrode provided by still another embodiment of the invention;

FIG. 9 is a structural schematic diagram showing an arrangement direction of a pixel electrode and a common electrode provided by another embodiment of the invention;

FIG. 10 is a structural schematic diagram of a pixel structure provided by another embodiment of the invention;

FIG. 11 is a cross-sectional schematic diagram of a pixel structure provided by an embodiment of the invention;

FIG. 12 is a structural schematic diagram of a pixel structure provided by yet another embodiment of the invention;

FIG. 13 is a flow chart of a method for manufacturing a pixel structure provided by an embodiment of the invention;

FIG. 14 is a schematic diagram of a first structure obtained from a method for manufacturing a pixel structure provided by an embodiment of the invention;

FIG. 15 is a schematic diagram of a second structure obtained from a method for manufacturing a pixel structure provided by an embodiment of the invention;

FIG. 16 is a schematic diagram of a third structure obtained from a method for manufacturing a pixel structure provided by an embodiment of the invention;

FIG. 17 is a schematic diagram of a fourth structure obtained from a method for manufacturing a pixel structure provided by an embodiment of the invention; and

FIG. 18 is a schematic diagram of a fifth structure obtained from a method for manufacturing a pixel structure provided by an embodiment of the invention.

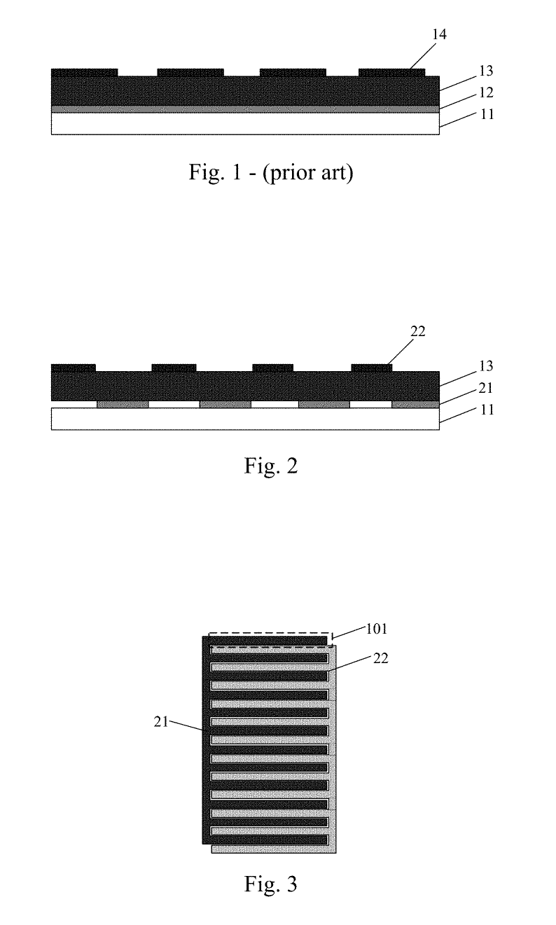

### DETAILED DESCRIPTION OF THE INVENTION

In the following, the technical solutions in embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

The thickness of the layers and the size and shape of the areas in the drawings do not reflect the true proportion of the pixel structure and the components of the array substrate, but are intended to illustrate only the content of the present invention.

The embodiments of the invention provide a pixel structure and a method for manufacturing the same, an array substrate and a display panel.

### Embodiment 1

As shown in FIG. 2, an embodiment of the invention provides a pixel structure. The pixel structure includes a plurality of pixel units arranged in an array. Each pixel unit includes a common electrode 21 and a pixel electrode 22 arranged in different layers of a basal substrate 11. An orthographic projection of the common electrode 21 on the basal substrate 11 does not overlap with an orthographic projection of the pixel electrode 22 on the basal substrate 11.

An insulating layer 13 can also be arranged between the common electrode 21 and the pixel electrode 22.

It should be noted that it is only an embodiment of the present invention that the orthographic projection of the common electrode on the basal substrate and the orthographic projection of the pixel electrode on the basal substrate have no overlapping area. The protection scope of the embodiment of the present invention also includes the arrangement in which a mutual capacitance generated by an overlapping area of the orthographic projection of the common electrode on the basal substrate and the orthographic projection of the pixel electrode on the basal substrate is small enough.

In the pixel structure provided by the embodiment of the invention, the common electrode and the pixel electrode arranged in different layers are designed so that the orthographic projection of the common electrode on the basal substrate does not overlap with the orthographic projection of the pixel electrode on the basal substrate. Therefore the storage capacitance between the pixel electrode and the common electrode is reduced, improving the charge rate of the pixel.

According to another embodiment of the invention, as show in FIG. 3, both the pixel electrode 22 and the common electrode 21 are comb electrodes, and the pixel electrode 22 and the common electrode 21 are arranged in an interdigitated structure.

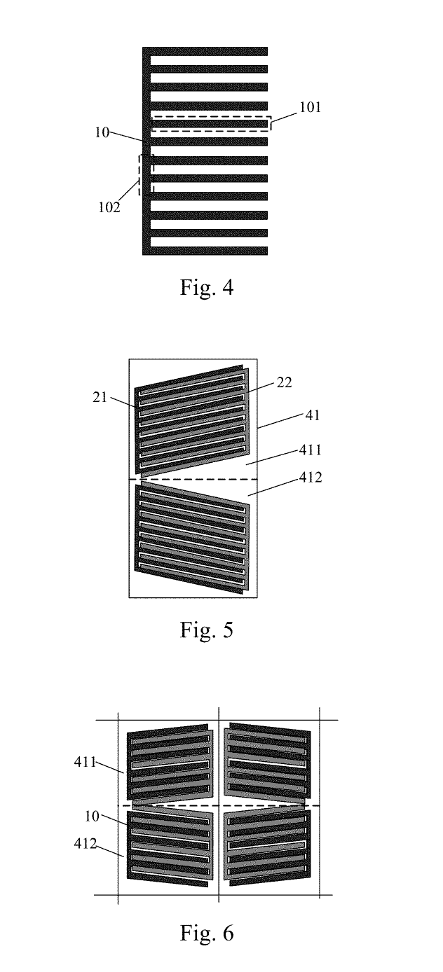

It should be noted that, as shown in FIG. 4, the comb electrode 10 includes, for example, strip electrodes 101 and a connecting electrode 102. A gap exists between two adjacent strip electrodes 101. The connecting electrode 102 connects the strip electrodes 101. The structure exemplarily shown in FIG. 4 can be referred to as a comb electrode. As shown in FIG. 3, two comb electrodes are arranged facing to each other, and a strip electrode 101 of a comb electrode is arranged in the gap between two strip electrodes of the other comb electrode, making no overlapping area between these comb electrodes. The arrangement of the structure exemplarily shown in FIG. 3 can be referred to as an interdigitated structure.

In particular, both the pixel electrode and the common electrode can be designed as comb electrodes. The pixel electrode and the common electrode can be arranged in an interdigitated structure, so that the orthographic projection of the common electrode on the basal substrate and the orthographic projection of the pixel electrode on the basal substrate have no overlapping area. Ion this way, the storage capacitance between the pixel electrode and the common electrode is reduced, improving the charge rate of the pixel.

In some embodiments of the invention, the comb electrodes of the pixel electrode and the common electrode can be arranged in an interdigitated structure, thus an electric field can be generated between the pixel electrode and the adjacent common electrode. It should be emphasized that if the pixel electrode and the common electrode are arranged in the same layer, the pixel electrode and the common electrode can also be designed as comb electrodes, and the pixel electrode and the common electrode can also be arranged in an interdigitated structure. In this way, an electric field can be generated between the pixel electrode and the adjacent common electrode, thereby driving the liquid crystal to deflect and performing display.

It should be noted that, the modification on the pixel electrode and the common electrode structure and the modification on the extending direction of the comb electrode in the following embodiments can also be applied in the pixel structure in which the common electrode and the pixel electrode are arranged in the same layer.

According to another embodiment of the invention, as shown in FIG. 5, each pixel unit 41 includes a first display area 411 and a second display area 412. In the first display area 411, the comb electrode of the pixel electrode 22 and the comb electrode of the common electrode 21 are arranged along the same extending direction. In the second display area 412, the comb electrode of the pixel electrode 22 and the comb electrode of the common electrode 21 are arranged along the same extending direction. The extending direction of the comb electrode in the first display area 411 is different from the extending direction of the comb electrode in the second display area 412.

It should be noted that, in the embodiments of the present invention, the pixel unit is divided into two display areas in order to illustrate that the pixel electrodes and the common electrodes of the two display areas are arranged in different directions. Of course, the arrangement directions of the pixel electrode and the common electrode in the pixel unit can also be the same direction, and the two display areas included in the pixel unit are the same. In the embodiment of the invention, the area of the first display area and the area of the second display area can be the same or different, which are not limited herein.

As shown in FIG. 5, in each pixel unit, the extending direction of the comb electrode in the first display area 411 is different from the extending direction of the comb electrode in the second display area 412, therefore, each pixel unit presents a double-domain structure. FIG. 5 is a structural schematic diagram showing a pixel unit, in which the extending direction of the comb electrode in the first display area is different from the extending direction of the comb electrode in the second display area. However, it doesn't mean that the comb electrode(s) can only be arranged with the extending direction as shown in FIG. 5. Of course, the extending direction of the comb electrode in the first display area can also be same to the extending direction of the comb electrode in the second display area, which is not limited herein.

It should be noted that, in the embodiment of the invention, each pixel unit includes two display areas (i.e., a first display area and a second display area), and the extending direction of the comb electrode in the first display area is different from the extending direction of the comb electrode in the second display area. The extending directions of the comb electrodes of the first display areas in two adjacent pixel units can be the same or different. The extending directions of the comb electrodes in the second display areas of two adjacent pixel units can be the same or different. FIG. 5 only shows the extending directions of the comb electrodes in one pixel unit. FIG. 6 shows the extending directions of the comb electrodes in two adjacent pixel units. Although FIG. 6 shows only two adjacent pixel units, a similar structure can be applied to other pixel units. In FIG. 6, the extending direction of the comb electrode 10 in the first display area 411 of the left pixel unit is different from the extending direction of the comb electrode 10 in the first display area 411 of the right pixel unit, the extending direction of the comb electrode 10 in the second display area 412 of the left pixel unit is different from the extending direction of the comb electrode 10 in the second display area 412 of the right pixel unit. Therefore, the electric field produced by each pixel unit in FIG. 6 has four different electric field directions. Under the driving of the electric field, the deflection direction of the liquid crystal is different, realizing the pixel design of a four-domain structure.

According to another embodiment of the invention, each pixel unit includes two display areas, and the arrangement directions of the pixel electrode and the common electrode in each display area are different, so that the viewing angle can be increased and the color cast can be corrected.

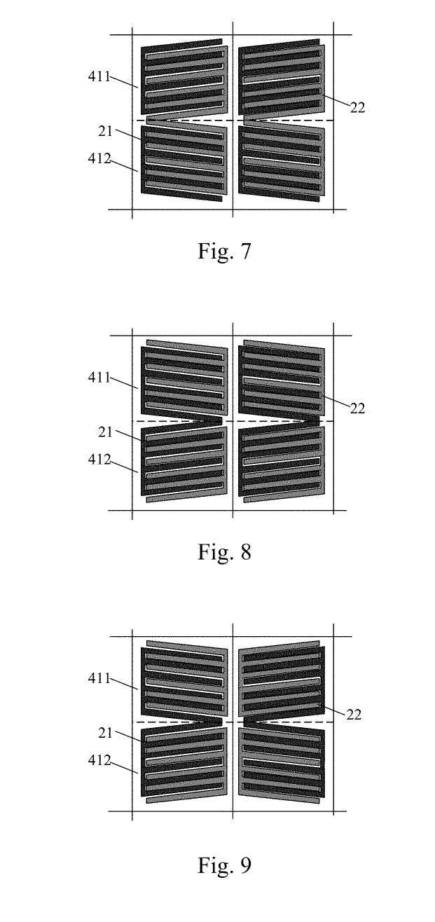

According to another embodiment of the invention, as shown in FIG. 7, the extending directions of the comb electrodes of the pixel electrode 22 and the common electrode 21 in the first display areas 411 of the plurality of pixel units are the same, and the extending directions of the comb electrodes of the pixel electrode 22 and the common electrode 21 in the second display areas 412 of the plurality of pixel units are the same.

In particular, the comb electrodes in all the first display areas in the pixel structure extend in the same direction, and the comb electrodes in all the second display areas in the pixel structure extend in another direction. The extending direction of the comb electrode in the first display area is different from the extending direction of the comb electrode in the second display area. Since the pixel structure has two extending directions of the comb electrode, the electric field with two directions can be generated to drive the liquid crystal for displaying.

FIG. 7 shows that the extending direction of the comb electrode in the first display area is different from the extending direction of the comb electrode in the second display area, but the present invention is not limited to extending only in these two directions.

According to another embodiment of the invention, as shown in FIG. 8, in each pixel unit, the comb electrode of the pixel electrode 22 and the common electrode 21 in the first display area 411 is symmetrically distributed with the comb electrode of the pixel electrode 22 and the common electrode 21 in the second display area 412, and a boundary line between the first display area 411 and the second display area 412 is the symmetrical axis.

In order to improve the display uniformity of the pixel structure, in each pixel unit, the extending direction of the comb electrode in the first display area is symmetrically distributed with the extending direction of the comb electrode in the second display area. This can increase the viewing angle and correct the color cast. For example, the pixel structure provided in FIG. 8 has a V-shaped structure.

According to another embodiment of the invention, as shown in FIG. 9, in two adjacent columns of pixel units, the extending direction of the comb electrodes in the first display areas of one column of pixel units is different from the extending direction of the comb electrodes in the first display areas of the other column of pixel units. In two adjacent columns of pixel units, the extending direction of the comb electrodes in the second display areas of one column of pixel units is different from the extending direction of the comb electrodes in the second display areas of the other column of pixel units. In each pixel unit, the comb electrode in the first display area is symmetrically distributed with the comb electrode in the second display area, and a boundary line between the first display area and the second display area is the symmetrical axis. In two adjacent columns of pixel units, the comb electrodes of the pixel electrode 22 and the common electrode 21 are symmetrically distributed with respect to a gap between these two adjacent columns of pixel units.

It should be noted that FIG. 9 is a schematic diagram of a pixel structure that is further modified on the basis of FIG. 8. More specifically, in each pixel unit, the comb electrode in the first display area is symmetrically distributed with the comb electrode in the second display area, and a boundary line between the first display area and the second display area is the symmetrical axis. In two adjacent columns of pixel units, the comb electrodes of the pixel electrode 22 and the common electrode 21 are symmetrically distributed with respect to a gap between these two adjacent columns of pixel units, so that the pixel structure has an X-shaped structure.

In addition, in pixel structure design, the pixel structure of FIG. 9 can also be formed without the basis of the pixel structure in FIG. 8. That is, in two adjacent columns of pixel units, the comb electrodes can be symmetrically distributed with respect to a gap between these two adjacent columns of pixel units.

The comb electrodes in two adjacent columns of pixel units are symmetrically distributed with respect to the gap between these two adjacent columns of pixel units, so that the display uniformity of the pixel structure is improved, the color cast can be corrected and the viewing angle can be increased.

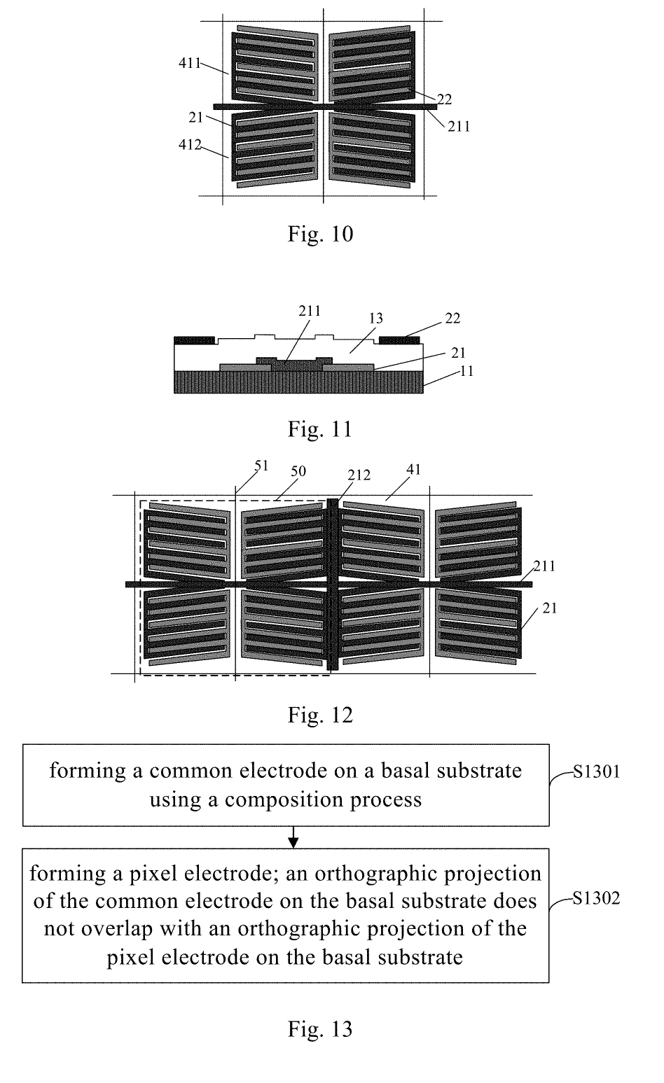

According to another embodiment of the invention, as shown in FIG. 10, the pixel structure further includes a first common electrode line 211 located at the boundary line between the first display area 411 and the second display area 412. The first common electrode line 211 connects the common electrode 21 in the first display area 411 and the common electrode 21 in the second display area 412.

It should be noted that the material of the first common electrode line can be the same as the material of the common electrode. The first common electrode line connects the common electrode in the first display area and the common electrode in the second display area, thereby reducing the impedance of the common electrodes. In addition, since the extending direction of the comb electrode of the common electrode in the first display area is different from that in the second display area, there is no common electrode located at the boundary of the first display area and the second display area, the electric field is weak, forming an area of poor display. In the embodiment of the invention, the first common electrode line is arranged at the boundary line between the first display area and the second display area, so as to reduce or avoid the problem of poor display in this area.

The first common electrode line can be arranged at the edge of the pixel unit, and the gate line can be arranged in the same layer with the first common electrode line. In order to prevent short circuit between the gate line and the first common electrode line, a distance between the first common electrode line and the gate line is required. This may cause a poor display area in the middle of each pixel unit. The aperture ratio of the pixel unit may be reduced due to the distance between the first common electrode line and the gate line.

Therefore, according to the embodiment of the invention, the first common electrode line can be arranged at the boundary line between the first display area and the second display area in the pixel unit. The problem of poor display area in the pixel unit can thus be effectively eliminated or avoided. Compared with the design in which the first common electrode line is near the gate line, the aperture ratio of the pixel unit can be improved.

Specifically, to clearly illustrate the position of the first common electrode line, FIG. 11 shows a cross-sectional view at the boundary between the first display area and the second display area. As shown in FIG. 11, a common electrode 21 and a first common electrode line 211 are sequentially arranged on the basal substrate 11, and the first common electrode line 211 is located between two adjacent common electrodes 21 and above these two adjacent common electrodes 21, connecting these two adjacent common electrodes 21. The pixel structure also includes an insulating layer 13 between the common electrode 21 and the pixel electrode 22.

According to another embodiment of the invention, as shown in FIG. 12, each two adjacent columns of pixel units 41 constitute a pixel unit group 50, and the pixel units in the pixel unit group are different. The pixel units in a pixel unit group share a data line 51. A second common electrode line 212 is arranged between two adjacent pixel unit groups, and the second common electrode line 212 connects the common electrodes 21 in two columns of pixel units adjacent to the second common electrode line 212.

In general, the pixel structure includes a pixel structure with a single gate and a pixel structure with double gates. Specifically, data lines and gate lines can be disposed between the pixel units of the pixel structure. For the pixel structure with a single gate, the gate line is located between two adjacent rows of pixel units, and the data line is located between two adjacent columns of pixel units. That is, if a data line is located between two adjacent columns of pixel units, the pixel structure is a pixel structure with a single gate. In a pixel structure with a single gate, each data line is used to provide a voltage signal to a column of pixel units adjacent to the data line. In a pixel structure with a single gate, only the first common electrode line can be provided. For example, as shown in FIG. 10, a first common electrode line is provided at the boundary between the first display area and the second display area in each pixel unit. For a pixel structure with double gates, as shown in FIG. 12, two adjacent columns of two pixel units constitute a pixel unit group. If the pixel units in each pixel unit group 50 share a data line 51, the pixel structure is a pixel structure with double gates. In the pixel structure of double gates shown in FIG. 12, each data line 51 is used to provide a voltage signal to two columns of pixel units 41 adjacent to the data line, but there is no data line between two adjacent pixel unit groups. The second common electrode line 212 connects the common electrodes 21 in two columns of pixel units adjacent to the second common electrode line 212, thereby reducing the resistance of the common electrodes.

According to another embodiment of the invention, the number of the second common electrode line is more than one. The second common electrode lines are arranged in the same layer with a gate line. The second common electrode lines are electrically connected to each other by means of a plurality of via holes, and each via hole is arranged near a cross position of the second common electrode line and the gate line.

For example, if the second common electrode lines are vertically arranged and the gate lines are horizontally arranged, in order to prevent a short circuit between the second common electrode lines and the gate lines, a plurality of via holes can be arranged in the insulating layer above the second common electrode lines. The electrical connection across the gate line for the plurality of second common electrode lines is then achieved through a plurality of via holes and a conductive layer covering the via holes (e.g., pixel electrode, etc.).

In summary, in the pixel structure provided by the embodiment of the invention, the common electrode and the pixel electrode arranged in different layers are designed so that the orthographic projection of the common electrode on the basal substrate does not overlap with the orthographic projection of the pixel electrode on the basal substrate. Therefore the storage capacitance between the pixel electrode and the common electrode is reduced, improving the charge rate of the pixel. For example, the pixel electrode and the common electrode can be designed as comb electrodes and arranged in an interdigitated structure so that the orthographic projection of the common electrode on the basal substrate and the orthographic projection of the pixel electrode on the basal substrate have no overlapping area. Each pixel unit includes e.g. a first display area and a second display area. In the first display area, the comb electrode(s) is arranged along a first extending direction. In the second display area, the comb electrode(s) is arranged along a second extending direction. Therefore, the viewing angle can be increased and the color cast can be corrected. In addition, the pixel structure can further include a first common electrode line located at the boundary line between the first display area and the second display area. The first common electrode line connects the common electrode in the first display area and the common electrode in the second display area. The first common electrode line can reduce or avoid the problem of poor display area. The first common electrode line is arranged at the boundary line between the first display area and the second display area, therefore, compared with the design in which the first common electrode line is arranged at the edge of the pixel unit, the aperture ratio of the pixel unit can be improved.

It should be noted that, if the pixel electrode and the common electrode layer are arranged in the same layer, the pixel electrode and the common electrode can also be designed as comb electrodes provided by the embodiment of the invention, and the pixel electrode and the common electrode can be arranged in an interdigitated structure. Specifically, each pixel unit includes e.g. a first display area and a second display area. In the first display area, the comb electrode(s) is arranged along a first extending direction. In the second display area, the comb electrode(s) is arranged along a second extending direction. Therefore, the viewing angle can be increased and the color cast can be corrected, thereby providing a display effect of multi-domain. In addition, the pixel structure can further include a first common electrode line located at the boundary line between the first display area and the second display area. The first common electrode line connects the common electrode in the first display area and the common electrode in the second display area. The first common electrode line can reduce or avoid the problem of poor display area. The first common electrode line is arranged at the boundary line between the first display area and the second display area, therefore, compared with the design in which the first common electrode line is arranged at the edge of the pixel unit, the aperture ratio of the pixel unit can be improved.

An embodiment of the invention further provides an array substrate including the abovementioned pixel structure.

It should be noted that the array substrate in the embodiment of the invention can also include a pixel structure in which a pixel electrode and a common electrode are arranged in the same layer.

An embodiment of the invention further provides a display panel including the abovementioned array substrate.

### Embodiment 2

A method for manufacturing the pixel structure according to the embodiment of the invention is described in detail below.

As shown in FIG. 13, an embodiment of the invention provides a method for manufacturing the abovementioned pixel structure. The method includes the following steps:

S1301, forming a common electrode on a basal substrate using a composition process, and

S1302, forming a pixel electrode. An orthographic projection of the common electrode on the basal substrate does not overlap with an orthographic projection of the pixel electrode on the basal substrate.

It should be noted that, since the common electrode and the pixel electrode are successively formed on the basal substrate, and the orthographic projection of the common electrode on the basal substrate and the orthographic projection of the pixel electrode on the basal substrate have no overlapping area, the storage capacitance between the common electrode and the pixel electrode can be reduced, thereby improving the charge rate of the pixel.

According to another embodiment of the invention, the step of S1301 forming a common electrode on a basal substrate using a composition process includes: forming a common electrode by an exposure development process using a mask plate. The common electrode is a comb electrode.

The structure of the common electrode provided in the embodiment of the present invention may be the same as that of the common electrode described in Embodiment 1, both of which are comb electrodes. The comb electrodes of the common electrodes can be arranged in different directions as described in Embodiment 1. Since the method of forming the common electrode is known to those skilled in the art, it can be achieved by an exposure development process or the like, which will not be described in detail herein. The pattern of the mask plate for forming the common electrode in the embodiment of the present invention may be the same pattern as the comb electrode.

According to another embodiment of the invention, the step of S1302 forming a pixel electrode includes: forming a pixel electrode by an exposure development process using a mask plate. The pixel electrode is a comb electrode. The pixel electrode and the common electrode are arranged in an interdigitated structure.

The structure of the pixel electrode provided in the embodiment of the present invention may be the same as that of the pixel electrode described in Embodiment 1, both of which are comb electrodes. The comb electrodes of the pixel electrodes can be arranged in different directions as described in Embodiment 1. Since the method of forming the pixel electrode is known to those skilled in the art, it can be achieved by an exposure development process or the like, which will not be described in detail herein. The pattern of the mask plate for forming the pixel electrode in the embodiment of the present invention may be the same pattern as the comb electrode.

According to another embodiment of the invention, the mask plate can be a halftone mask plate, a gray tone mask plate or a mask plate with slits.

According to another embodiment of the invention, after the step of forming a common electrode and before the step of forming a pixel electrode, the method further includes forming a first common electrode line on the common electrode.

It should be noted that, after forming the common electrode, a boundary is between the comb electrodes of the common electrodes extending in two different directions. In order to prevent the common electrode from generating a large resistance at the boundary, a first common electrode line can be provided to connect the common electrodes extending in different directions, and the first common electrode line is located above the common electrodes. Since the material and method for forming the first common electrode line may be the same as those for forming the common electrode, they will not be described herein.

According to another embodiment of the invention, the method further includes: forming a second common electrode line while forming the first common electrode line.

It should be noted that, for a pixel structure with double gates, a second common electrode line may be provided to connect the common electrodes in two columns of pixel units adjacent to the second common electrode line. The second common electrode line and the first common electrode line can be formed simultaneously. The second common electrode line can be arranged in the same layer as the first common electrode line. Since the gate lines are formed after forming the common electrodes, the second common electrode lines can be arranged in the same layer as the gate lines. For example, each two adjacent columns of pixel units constitute a pixel unit group, and the second common electrode line is located between two adjacent pixel cell groups. A gate line is located between two adjacent rows of pixel units. The number of the second common electrode line can be more than one. A plurality of via holes can be arranged in the insulating layers above the second common electrode lines, and each via hole is arranged near a cross position of the second common electrode line and the gate line. The electrical connection across the gate line for the plurality of second common electrode lines is then achieved through a plurality of via holes and a conductive layer covering the via holes (e.g., pixel electrode, etc.). Therefore, the gate line can be insulated from the second common electrode line.

It should be noted that the method of manufacturing the pixel structure provided by the embodiment of the present invention is exemplarily described with the common electrode and the pixel electrode arranged in different layers. The method provided by the embodiment of the present invention is also applicable to the pixel structure with the common electrode and the pixel electrode arranged in the same layer, which will not be described herein.

In order to describe the method of manufacturing the pixel structure provided by the embodiment of the present invention in more detail, a specific example is provided.

A method for manufacturing a pixel structure with double gates is introduced as an example. The method includes the following steps.

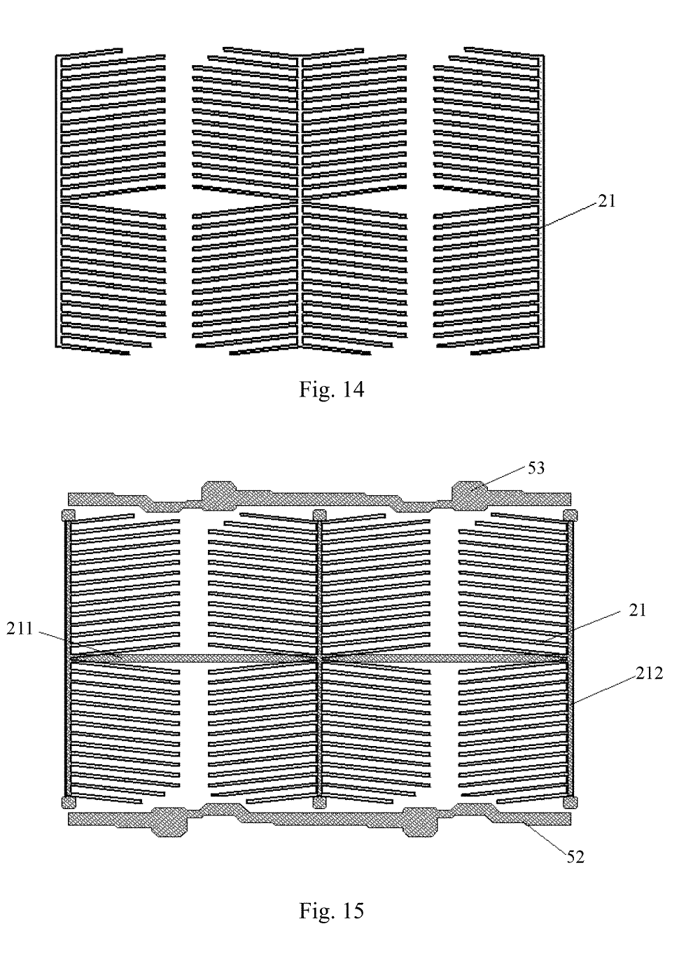

Step 1, as shown in FIG. 14, a common electrode 21 is formed on a glass substrate (i.e., basal substrate) by an exposure development process using a mask plate.

Step 2, as shown in FIG. 15, a gate layer 53, a gate line 52, a first common electrode line 211 and a second common electrode line 14 are formed on the structure shown in FIG. 14. The first common electrode line 211 and the second common electrode line 212 partially overlap with the common electrode 21 and are electrically connected to the common electrode 21.

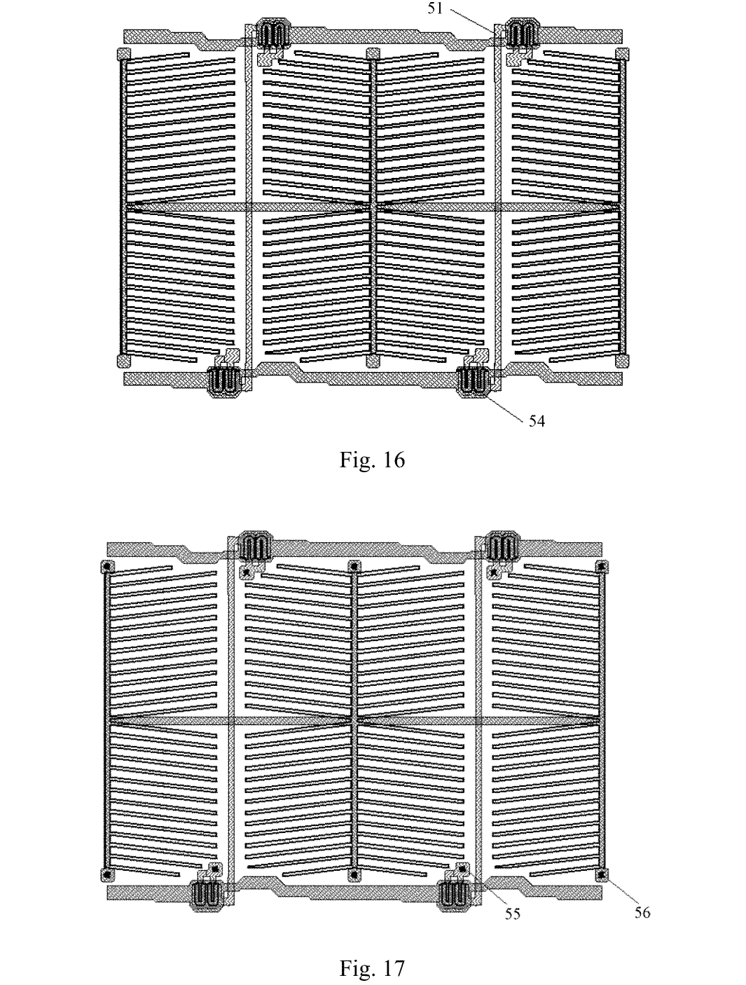

Step 3, as shown in FIG. 16, a gate insulating layer, an active layer and a source-drain layer are provided to form a thin film transistor 54

Step 4, as shown in FIG. 17, a passivation layer is formed and a via hole 55 is formed in the passivation layer by means of a dry etching process. Through the via hole 55, the source of the thin film transistor can be electrically connected with a pixel electrode, which is formed in the next step. In addition, a via hole 56 may be formed. A conductive layer (e.g., pixel electrode, etc.) can then be covered on the via hole 56, and the electrical connection across the gate line for the second common electrode lines at different positions can be achieved by means of the conductive layer.

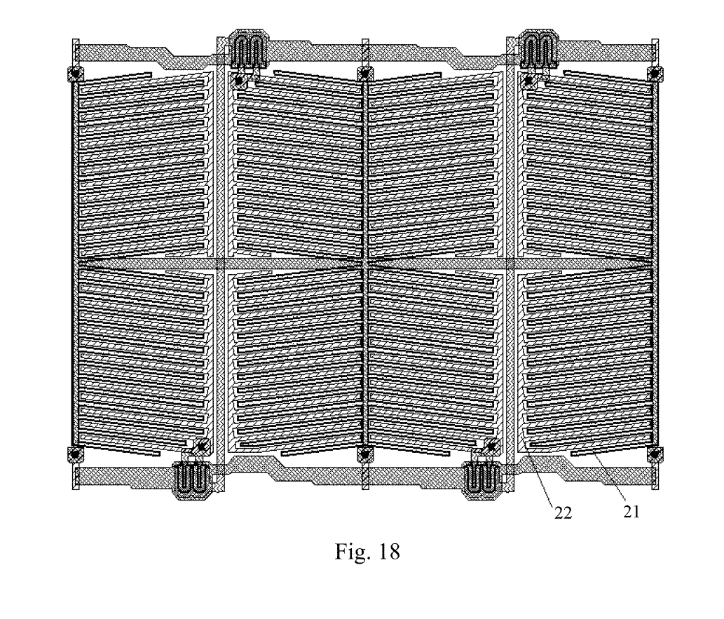

Step 5, as shown in FIG. 18, a pixel electrode 22 is formed, and the pixel electrode 22 is a comb electrode. An orthographic projection of the common electrode 21 on the basal substrate does not overlap with an orthographic projection of the pixel electrode 22 on the basal substrate.

It should be noted that the method for manufacturing a pixel structure with double gates is only introduced as an example for the method provided by the embodiment of the invention. The method is also applicable to the pixel structure with a single gate. In the pixel structure provided by the embodiment of the invention, the extending direction of the comb electrode is only described as an example, in which the comb electrodes of two adjacent pixel units are arranged in an X-shaped structure. The method is also applicable to comb electrodes with other extending directions.

In the method for manufacturing the pixel structure provided by the embodiment of the invention, a common electrode is formed on the basal substrate by an exposure development process, then a pixel electrode is formed, and the orthographic projection of the common electrode on the basal substrate does not overlap with the orthographic projection of the pixel electrode on the basal substrate. Therefore the storage capacitance between the pixel electrode and the common electrode is reduced, improving the charge rate of the pixel.

In summary, in the pixel structure provided by the embodiment of the invention, the common electrode and the pixel electrode arranged in different layers are designed so that the orthographic projection of the common electrode on the basal substrate does not overlap with the orthographic projection of the pixel electrode on the basal substrate. Therefore the storage capacitance between the pixel electrode and the common electrode is reduced, improving the charge rate of the pixel. For example, the pixel electrode and the common electrode can be designed as comb electrodes and arranged in an interdigitated structure so that the orthographic projection of the common electrode on the basal substrate and the orthographic projection of the pixel electrode on the basal substrate have no overlapping area. Each pixel unit includes e.g. a first display area and a second display area. In the first display area, the comb electrode(s) is arranged along a first extending direction. In the second display area, the comb electrode(s) is arranged along a second extending direction. Therefore, the viewing angle can be increased and the color cast can be corrected. In addition, the pixel structure can further include a first common electrode line located at the boundary line between the first display area and the second display area. The first common electrode line connects the common electrode in the first display area and the common electrode in the second display area. The first common electrode line can reduce or avoid the problem of poor display area. The first common electrode line is arranged at the boundary line between the first display area and the second display area, therefore, compared with the design in which the first common electrode line is arranged at the edge of the pixel unit, the aperture ratio of the pixel unit can be improved.

Apparently, the person skilled in the art may make various alterations and variations to the invention without departing the spirit and scope of the invention. As such, provided that these modifications and variations of the invention pertain to the scope of the claims of the invention and their equivalents, the invention is intended to embrace these alterations and variations.

1. A pixel structure comprising: a plurality of pixel units arranged in an array, wherein each pixel unit comprises a common electrode and a pixel electrode arranged in different layers of a basal substrate; wherein an orthographic projection of the common electrode on the basal substrate does not overlap with an orthographic projection of the pixel electrode on the basal substrate.

2. The pixel structure according to claim 1, wherein both the pixel electrode and the common electrode are comb electrodes, and the pixel electrode and the common electrode are arranged in an interdigitated structure.

3. The pixel structure according to claim 2, wherein each pixel unit comprises a first display area and a second display area;
wherein in the first display area, the comb electrode of the pixel electrode and the comb electrode of the common electrode are arranged along the same extending direction; in the second display area, the comb electrode of the pixel electrode and the comb electrode of the common electrode are arranged along the same extending direction;
and wherein the extending direction of the comb electrode in the first display area is different from the extending direction of the comb electrode in the second display area.

4. The pixel structure according to claim 3, wherein the extending directions of the comb electrodes in the first display areas of the plurality of pixel units are the same, and the extending directions of the comb electrodes in the second display areas of the plurality of pixel units are the same.

5. The pixel structure according to claim 4, wherein in each pixel unit, the comb electrode in the first display area is symmetrically distributed with the comb electrode in the second display area, and a boundary line between the first display area and the second display area is the symmetrical axis.

6. The pixel structure according to claim 3, wherein in two adjacent columns of pixel units, the extending direction of the comb electrodes in the first display areas of one column of pixel units is different from the extending direction of the comb electrodes in the first display areas of the other column of pixel units; in two adjacent columns of pixel units, the extending direction of the comb electrodes in the second display areas of one column of pixel units is different from the extending direction of the comb electrodes in the second display areas of the other column of pixel units.

7. The pixel structure according to claim 6, wherein in each pixel unit, the comb electrode in the first display area is symmetrically distributed with the comb electrode in the second display area, and a boundary line between the first display area and the second display area is the symmetrical axis; and wherein in two adjacent columns of pixel units, the comb electrodes are symmetrically distributed with respect to a gap between these two adjacent columns of pixel units.

8. The pixel structure according to claim 7, further comprising a first common electrode line located at the boundary line between the first display area and the second display area; wherein the first common electrode line connects the common electrode in the first display area and the common electrode in the second display area.

9. The pixel structure according to claim 8, wherein each two adjacent columns of pixel units constitute a pixel unit group, and the pixel units in the pixel unit group are different; wherein pixel units in a pixel unit group share a data line; and wherein a second common electrode line is arranged between two adjacent pixel unit groups, and the second common electrode line connects the common electrodes in two columns of pixel units adjacent to the second common electrode line.

10. The pixel structure according to claim 9, wherein the number of the second common electrode line is more than one, the second common electrode lines are arranged in the same layer with a gate line; and wherein the second common electrode lines are electrically connected to each other by means of a plurality of via holes, each via hole is arranged near a cross position of the second common electrode line and the gate line.

11. An array substrate comprising the pixel structure according to claim 1.

12. A display device comprising the array substrate according to claim 11.

13. A method for manufacturing a pixel structure having a plurality of pixel units arranged in an array, wherein each pixel unit comprises a common electrode and a pixel electrode arranged in different layers of a basal substrate; wherein an orthographic projection of the common electrode on the basal substrate does not overlap with an orthographic projection of the pixel electrode on the basal substrate, the method comprising:
forming a common electrode on a basal substrate using a composition process; and
forming a pixel electrode; wherein an orthographic projection of the common electrode on the basal substrate does not overlap with an orthographic projection of the pixel electrode on the basal substrate.

14. The method according to claim 13, wherein the step of forming a common electrode on a basal substrate using a composition process comprises:
forming a common electrode by an exposure development process using a mask plate, the common electrode being a comb electrode.

15. The method according to claim 14, wherein the step of forming a pixel electrode comprises:
forming a pixel electrode by an exposure development process using a mask plate, the pixel electrode being a comb electrode; wherein the pixel electrode and the common electrode are arranged in an interdigitated structure.

16. The method according to claim 14, wherein the mask plate is a halftone mask plate, a gray tone mask plate or a mask plate with slits.

17. The method according to claim 15, wherein after the step of forming a common electrode and before the step of forming a pixel electrode, the method further comprises:
forming a first common electrode line on the common electrode.

18. The method according to claim 17, further comprising:
forming a second common electrode line while forming the first common electrode line.

19. The display device according to claim 12, wherein both the pixel electrode and the common electrode are comb electrodes, and the pixel electrode and the common electrode are arranged in an interdigitated structure.

20. The display device according to claim 19, wherein each pixel unit comprises a first display area and a second display area;
wherein in the first display area, the comb electrode of the pixel electrode and the comb electrode of the common electrode are arranged along the same extending direction; in the second display area, the comb electrode of the pixel electrode and the comb electrode of the common electrode are arranged along the same extending direction;
and wherein the extending direction of the comb electrode in the first display area is different from the extending direction of the comb electrode in the second display area.
